(19) United States
(12) Patent Application Publication
(10) Pub. No.: US 2012/0040580 A1
(43) Pub. Date: Feb. 16, 2012

(54) CANVAS FOR BREAKING DOWN LIGHT

(76) Inventors: Thierry D'Arras, Groslay (FR); Albert Paoli, Pontoise (FR)

(21) Appl. No.: 13/147,987

(22) PCT Filed: Feb. 4, 2010
(86) PCT No.: PCT/FR2010/000082

§ 371 Date: Oct. 21, 2011

(30) Foreign Application Priority Data
Feb. 4, 2009 (FR) 09/00467

(51) Int. Cl. D04H 13/00; B32B 5/00

(52) U.S. Cl. 442/327; 428/221

(57) ABSTRACT

The present invention relates to a canvas including a substrate and a layer for breaking down light characterised in that said layer includes mother-of-pearl or a substance with substantially identical light diffraction or iridescence properties, from UV range to the IR range, to mother-of-pearl.

### TECHNICAL FIELD

The present invention relates to a canvas comprising a support and a layer for breaking down light, characterised in that said layer comprises mother-of-pearl or a substance having light diffraction or iridescence properties, from the UV range to that of IR, substantially identical to that of the mother-of-pearl. The present invention also relates to processes for producing said canvas and the use of said canvas to produce canvases for blinds.

### BACKGROUND

Canvases are currently used to protect individuals from solar radiation in the form of parasols or blinds. These technical canvases must ideally strongly reject infrared rays and UV rays while allowing the passage of visible light.

Solutions currently commercially available concern canvases made with fibreglass, acrylic or polyester. This type of canvas rejects from 55% to 65% of infrared. Products called “blind film” composed of a polyester film enclosing particles of aluminium rejecting up to 94% of infrared are also known. These films are also sold in the form of an adhesive film for covering glassed surfaces.

There are also textiles treated by pigments and more particularly metallic pigments. Thus, patent application EP 0955404 proposes a textile strip, made with threads composed of different elements each having a melting different point, whereof the surface is coated by a layer comprising pigments of mother-of-pearl or equivalent, such as fines plaques of mica coated with titanium dioxide.

The U.S. Pat. No. 6,159,875 describes a blocking product, characterised in that the two faces of the product are treated by different pigments. These pigments comprise iridescent and opalescent pigments such as mica-based pigments.

The application WO 2004035911 describes a process of dyeing or printing of materials in textile fibre consisting of applying metallic pigments based on silicon oxides in layers or in dye.

The nature of those products used for production of these canvases limits their range of use. Also, even if films containing metallic particles properly reject infrared rays, they also reject visible light exaggeratedly opacifying the covered surfaces.

There is therefore a need for canvases having a wide range of use and allowing filtering of infrared and UV rays, while interfering as less as possible with visible light.

### SUMMARY

Thus, the present invention proposes new canvases for producing rejection of infrared of up to 98%, while allowing visible light to pass satisfactorily. The present invention is based on the diffractive and refractive properties of mother-of-pearl. In existing processes, protection is obtained by bouncing back infrared by reflection on metallic particles which also reject visible light. The canvas according to the invention comprises a layer for breaking down light which acts by diffraction and by refraction. Some of the rays return to the source of light, and some, turned away from their trajectory lose force by touching the layer for breaking down light tangentially. The product according to the invention lets through a bigger proportion of visible light than infrared. Mother-of-pearl has an extraordinary faculty for breaking light, and the size of its flakes, close to the wavelength of the targeted rays, diffracts light. Also, the anarchic arrangement of these flakes reorients the rays in all directions.

Thus, the present invention proposes especially a canvas comprising a support and a layer for breaking down light, characterised in that said layer comprises mother-of-pearl or a substance having light diffraction or iridescence properties, from the UV range to that of IR, substantially identical to that of mother-of-pearl.

### DETAILED DESCRIPTION

All kinds of support can be used within the scope of the invention. The choice of an adequate support will depend more particularly on the preferred use and aesthetic effect. It could especially be a non-woven or a textile. According to a preferred embodiment, the canvas according to the invention is remarkable in that the support is a non-woven. As defined in standard ISO9092, a non-woven is a manufactured product, comprising a web, a fleece or a mattress of any fibres, distributed directly or randomly and the internal cohesion of which is assured by mechanical, physical or chemical methods or/and by a combination of processes (with the exclusion of paper, and products obtained by other textile processes). Examples of non-wovens useable within the scope of the present invention are non-wovens composed in whole or part of mineral fibres, fibres of animal origin, vegetable fibres and/or chemical fibres. According to a more preferred embodiment, said non-woven is composed in whole or part of vegetable fibres and according to an even more preferred embodiment said non-woven is non-woven linen.

The morpholysis layer contained in the canvas according to the invention is distinguished from previous systems by the fact that it can be continuous, with spaces necessarily left in between the reflecting particles of the canvases of the prior art. Thus, the layer for breaking down light of canvases according to the invention is preferably continuous.

The canvas according to the invention comprises a layer for breaking down light. Said layer can be anywhere on the surface of the support or incorporated in the mass of the latter. Thus, according to a preferred embodiment, the invention relates to canvas comprising a support and a layer for breaking down light, remarkable in that said layer comprises mother-of-pearl or a substance having light diffraction or iridescence properties, from the UV range to that of IR, substantially identical to that of mother-of-pearl and in that said layer is incorporated in the mass of said support.

The term “mother-of-pearl” refers to mother-of-pearl in its different forms and especially in the form of mother-of-pearl powder. For the sake of clarity, it is specified that the term “mother-of-pearl powder” makes no reference to pigments known by names of “nacreous powder” or “nacreous pigments”. The latter two products correspond to pigments containing mica and metals such as titanium, aluminium, silicon, potassium and barium. Said “nacreous powder” or “nacreous pigments” are currently used in make-up and paints to produce irisated sheens. The applicant was able to disclose that canvases according to the invention exhibited a capacity to filter infrared rays and transmit visible light much greater than canvases of the prior art comprising nacreous pigments and/or metallic pigments.

According to a preferred embodiment of the invention, said mother-of-pearl is mother-of-pearl powder. Examples of powders of mother-of-pearl useable within the scope of the invention are especially mother-of-pearl powder coming from milling the interior of shells or molluscs.

According to another preferred embodiment of the invention, the substance having light diffraction or iridescence properties, from the UV range to that of IR, substantially identical to that of the mother-of-pearl is a composition comprising at least 50% aragonite.

According to a preferred embodiment, the canvas according to the invention contains no metallic particles.

According to a quite preferred embodiment, the canvas according to the invention contains neither metallic particles, nor mica.

The properties linked to the presence of the layer for breaking down light from the canvas according to the invention can advantageously be combined with those contributed by the presence of metallic particles such as used in canvases of the prior art. These properties can be combined especially in at least two different ways. According to a first embodiment, the canvas according to the invention further comprises a layer comprising metallic particles and/or powder of stone to be whetted. This additional layer can be placed anywhere above or below the layer for breaking down light. According to a second embodiment, the particles and/or the powder of stone to be whetted can be contained in the layer for breaking down light. Thus, the present invention relates to a canvas according to the invention, remarkable in that the layer for breaking down light further comprises metallic particles or particles with metallic reflections such as produced by the powder and/or the stone to be whetted.

Canvases according to the invention can be prepared according to several manufacturing processes. According to an embodiment, the canvases according to the invention are produced by a process comprising a step consisting of impregnating a support in a mother-of-pearl solution or a substance having of light diffraction or iridescence properties, from the UV range to that of IR, substantially identical to that of mother-of-pearl. This impregnation can be done by soaking the support in said solution. It can also be obtained by pulverising said solution on the surface of the support. According to another preferred embodiment, the mother-of-pearl or the substance having light diffraction or iridescence properties, from the UV range to that of IR, substantially identical to that of mother-of-pearl, is incorporated prior to making the support in the primary material composing said support. It was noticed during assays that mother-of-pearl powder simply spread as dust in tow or in linen comb waste gave a very good result.

The solutions of mother-of-pearl useable within the scope of the process according to the invention can have a variable concentration. Advantageously, the applicants were able to observe that particularly advantageous results are obtained by using a solution of mother-of-pearl powder comprising from 10 to 20% mother-of-pearl powder.

Canvases according to the invention and canvases obtained by a process according to the invention can be used to make numerous products. Thus, the canvas according to the invention and/or canvases obtained by a process according to the invention can be advantageously used for making products which reject infrared, such as blind canvases, canvases for tents and clothing.

1. A canvas comprising a support and a layer for breaking down light, the layer comprising one of a mother-of-pearl and a substance having light diffraction or iridescence properties, from the ultraviolet (UV) range to that of infrared (IR), substantially identical to that of mother-of-pearl.

2. The canvas according to claim 1, wherein the layer is incorporated in the mass of the support.

3. The canvas according to claim 1, wherein the support is a non-woven.

4. The canvas according to claim 3, wherein the non-woven is chosen from the group comprising non-wovens composed at least in part from mineral fibres, fibres of animal origin, vegetable fibres and chemical fibres.

5. The canvas according to claim 4, wherein the non-woven is a non-woven linen.

6. The canvas according to claim 1, wherein the layer for breaking down light is continuous.

7. The canvas according to claim 1, further comprising a layer comprising at least one of metallic particles and particles with metallic reflections.

8. The canvas according to claim 1, wherein the layer for breaking down light further comprises at least one of metallic particles and powder of stone to be whetted.

9. A process for producing canvas according to claim 1, the process comprising: a step consisting of impregnating the support in a mother-of-pearl solution.

10. The process according to claim 9, wherein the mother-of-pearl solution comprises from 10 to 20% mother-of-pearl.

11. A method of use of the canvas according to claim 1 for making products rejecting infrared, such as blind canvases, canvases for tents and clothing.
